(19) United States
(12) Patent Application Publication
(10) Pub. No.: US 2016/0215759 A1
(43) Pub. Date: Jul. 28, 2016

(54) METHODS AND SYSTEMS FOR WIND PLANT POWER OPTIMIZATION

(71) Applicants: Alliance for Sustainable Energy, LLC, Golden, CO (US); Technical University Delft, Delft (NL)

(72) Inventors: Paul FLEMING, Golden, CO (US); Pieter M.O. GEBRAAD, Golden, CO (US)

(21) Appl. No.: 15/009,313

(22) Filed: Jan. 28, 2016

Related U.S. Application Data
(60) Provisional application No. 62/109,009, filed on Jan. 28, 2015.

(51) Int. Cl. F03D 7/04

(52) U.S. Cl. CPC F03D 7/046

(57) ABSTRACT

A system includes at least one processor and at least one module operable by the at least one processor to receive at least one sensor measurement. The at least one sensor measurement may include at least one of a wind speed measurement, or a wind direction measurement. The at least one module may be further operable to determine, using a stochastic filter, and based on the at least one sensor measurement, at least one predicted attribute of a wake generated by a wind turbine, the wind turbine being one of a plurality of wind turbines of a wind plant. The at least one module may be further operable to modify, based on the at least one predicted attribute of the wake, at least one wind turbine control variable for at least one wind turbine of the plurality of wind turbines and output the at least one wind turbine control variable

This application claims the benefit of U.S. Provisional Application No. 62/109,009, filed Jan. 28, 2015 and titled “METHODS AND SYSTEM FOR CONTROLLING THE POWER OUTPUT FROM A WIND PLANT,” the entire content of which is incorporated herein by reference.

### CONTRACTUAL ORIGIN

The United States Government has rights in this invention under Contract No. DE-AC36-08GO28308 between the United States Department of Energy and Alliance for Sustainable Energy, LLC, the Manager and Operator of the National Renewable Energy Laboratory.

### BACKGROUND OF DISCLOSURE

There is a growing interest in the design of wind plant control systems to coordinate the controls of individual turbines to achieve improvements in the overall wind plant performance, such as total power production. In some related art methods, individual turbine controls are adjusted to improve the total output of the plant above what would be achieved if each turbine pursued its individual optimal output. In general, related art methods look to improve performance by accounting for the way turbines interact in a plant through their wakes, which can negatively impact performance.

To date, methods and systems for improving plant performance are mostly based on simulations and assume known, steady-state conditions. However, one obstacle to the introduction of optimization methods to actual wind plants in the field has been the complexity of wind and turbine wake interactions dynamically occurring in the wind plant's actual atmospheric environment. Wind and wake directions are continually changing, and turbine wakes meander as they propagate downstream. This introduces a problem for techniques that rely on constant, steady-state information about wind and wake locations. Additionally, to be practically useful, a wind plant's power optimization or control method should respond in a reasonable amount of time. Otherwise, adjustments to control parameters of the turbines such as tilt, pitch, and yaw will be unable to respond quickly enough to make a sustainable improvement to the wind turbine plant's power production.

### SUMMARY

In one example, a method includes receiving, by a computing system, at least one sensor measurement, the at least one sensor measurement including at least one of a wind speed measurement, or a wind direction measurement. The method also includes determining, by the computing system, using a stochastic filter, and based on the at least one sensor measurement, at least one predicted attribute of a wake generated by a wind turbine. The wind turbine may be one of a plurality of wind turbines of a wind plant. The method further includes modifying, by the computing system and based on the at least one predicted attribute of the wake, at least one wind turbine control variable for at least one wind turbine of the plurality of wind turbines, and outputting, by the computing system, the at least one wind turbine control variable.

In another example, a system includes at least one processor and at least one module operable by the at least one processor to receive at least one sensor measurement. The at least one sensor measurement may include at least one of a wind speed measurement, or a wind direction measurement. The at least one module is further operable by the at least one processor to determine, using a stochastic filter, and based on the at least one sensor measurement, at least one predicted attribute of a wake generated by a wind turbine, the wind turbine being one of a plurality of wind turbines of a wind plant. The at least one module is further operable by the at least one processor to modify, based on the at least one predicted attribute of the wake, at least one wind turbine control variable for at least one wind turbine of the plurality of wind turbines, and output the at least one wind turbine control variable.

In another example, a computer-readable storage medium is encoded with instructions that, when executed, cause at least one processor to receive at least one sensor measurement, the at least one sensor measurement including at least one of a wind speed measurement, or a wind direction measurement. The computer-readable storage medium is further encoded with instructions that cause the at least one processor to determine, using a stochastic filter, and based on the at least one sensor measurement, at least one predicted attribute of a wake generated by a wind turbine. The wind turbine may be one of a plurality of wind turbines of a wind plant. The computer-readable storage medium is further encoded with instructions that cause the at least one processor to modify, based on the at least one predicted attribute of the wake, at least one wind turbine control variable for at least one wind turbine of the plurality of wind turbines, and output the at least one wind turbine control variable.

### BRIEF DESCRIPTION OF DRAWINGS

FIG. 1 is a process diagram illustrating an example method for wind plant control, in accordance with one or more aspects of the present disclosure.

FIG. 2 is a block diagram illustrating an example wind plant control system, in accordance with one or more aspects of the present disclosure.

FIGS. 3A-3C are diagrams illustrating example operations of a particle filter for wake estimation, in accordance with one or more aspects of the present disclosure.

FIG. 4 is a diagram illustrating an example wake trajectory definition, in accordance with one or more aspects of the present disclosure.

FIG. 5 is a diagram illustrating an example relationship between turbine yaw misalignment and wake deflection, in accordance with one or more aspects of the present disclosure.

FIG. 6 is a graphical plot illustrating an example weighting function, in accordance with one or more aspects of the present disclosure.

FIG. 7 is a collection of images illustrating simulation results of wake estimation, in accordance with one or more aspects of the present disclosure.

FIG. 8 is a collection of images illustrating simulation results of wake estimation, in accordance with one or more aspects of the present disclosure.

FIG. 9 is a block diagram illustrating an example wind plant control system, in accordance with one or more aspects of the present disclosure.

FIG. 10 is a process diagram illustrating an example method for wind plant control, in accordance with one or more aspects of the present disclosure.

### DESCRIPTION OF EXEMPLARY EMBODIMENTS

Disclosed herein are systems and methods for wind plant control based on turbine wake location estimation using commonly available turbine sensor measurements. As one example, stochastic filtering methods may provide an approach for estimating wind turbine wakes using turbine sensor measurements positioned on at least one of the individual wind turbines themselves. The filtering method may determine at least one wake trajectory from at least one of the wind turbines within the wind power plant. The determined wake trajectory may then be coupled with wind plant control techniques, for example modified axial induction or wake redirection, to form a complete closed-loop control system for controlling the wind plant's power production. Embodiments of the proposed methods/systems may provide faster responses to the actual, dynamic, and random wind and wake disturbances known to occur in an actual wind plant environment. The end result of some embodiments are wind turbine control methods or systems that can improve the power capture and power output for a wind plant, even in the presence of dynamically changing weather and wind conditions.

Wind turbines extract energy from the kinetic energy of the wind flowing through a turbine's rotor. This results in a reduced wind speed downstream of the turbine and creates a wake downstream of the turbine. Thus, when wind turbines are located near each other in a wind plant, conditions can arise where one turbine is in the wake of another. This can produce the situation where the downstream turbine may underperform, for example, by capturing less wind energy.

Thus, the trajectories of the wakes produced in a wind plant are critically important as the propagation of each individual wake downstream may affect the power production and subsequent wake formation of downstream turbines. Because the wake may be in a turbulent three-dimensional wind flow, the wake may move in transverse directions in addition to the dominant wind flow direction. Given this effect, the location of a wake as it propagates downstream may be difficult to predict. However, as shown herein, various filter methods may provide a good estimate of wake locations, even with the use of only limited and constantly changing information. Such filter methods represent a unique and previously unrecognized approach for estimating turbine wake locations. The filter methods described herein, as well as similar methods, may provide dynamic and quick-responding control of turbine control elements, such as pitch, yaw, and tilt, to improve wind energy capture and wind plant power production, by for example, redirecting turbine wakes to minimize interactions between wakes and downstream turbines.

Various filtering methods may be used in accordance with the techniques described herein. For instance, systems and methods of the present disclosure may employ a particle filter, a Kalman filter, a point mass filter, or other stochastic filtering methods. For brevity, the methods of the present disclosure are described herein with respect to a particle filter.

A particle filter can be described as a method for predicting the state of a partially observable Markov chain in discrete time. The term “Markov chain” typically refers to a stochastic (random) process that exhibits the “Markov property”. The term “Markov property” typically refers to a memoryless property of a stochastic process. A stochastic process possesses the Markov property if the conditional probability distribution of future states of the process depends only upon the present state and not on the sequence of events that preceded it (thus the term “memoryless”). So, a Markov chain refers to a sequence of random states that a random process moves through, with the Markov property defining serial dependence only between adjacent periods of time (as in a “chain”). Therefore, a Markov chain may be used to describe random systems that follow a chain of linked states, where what happens next depends only on the current state of the system.

A particle filter typically represents a probability density function of a state as a set of samples or particles. One version of a particle filter that may be implemented in some embodiments detailed herein is described in publications by Rekleitis and Thrun, which are both incorporated herein by reference in their entirety (I. M. Rekleitis, “A particle filter tutorial for mobile robot localization,” Centre for Intelligent Machines, McGill University, vol. 3480, 2004; S. Thrun, “Particle filters in robotics,” in Proceedings of the 17^{th} Annual Conference on Uncertainty in AI (UAI), 2002).

A Kalman filter, generally, is a process that may use a series of measurements observed over time, containing statistical noise and other inaccuracies, and may produce estimates of unknown variables that tend to be more precise than those based on a single measurement alone. For instance, some Kalman filters may use a physical model of the system to predict a next time step, compare values of the predicted next step to measured values to determine an error of the model, and take the error as input when predicting a subsequent time step. Thus, Kalman filters used as described herein may produce accurate, continuous predictions of wind turbine wakes by regularly or continuously predicting a next state and comparing that next state to reality in order to more accurately produce subsequent states.

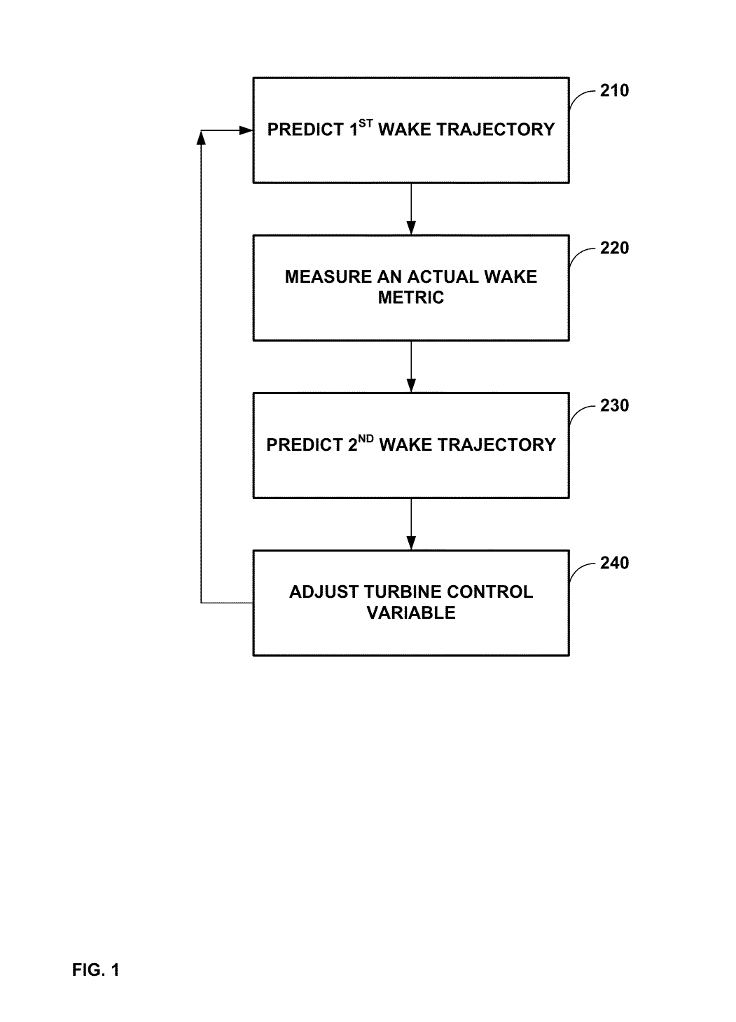

FIG. 1 is a flow diagram illustrating an example method for wind plant control, in accordance with one or more aspects of the present disclosure. More specifically, FIG. 1 illustrates one example method for controlling the power output from a wind plant utilizing a plurality of wind turbines. For instance, the example operations of FIG. 1 may be performed by a computer system, such as a wind plant controller. In various examples, the example method of FIG. 1 may be performed by any suitable device that includes at least one processor.

In the example of FIG. 1, the method for controlling the wind turbine plant includes predicting a first wake trajectory (210). For example, this may be done using a particle filter method. In some embodiments, a particle filter method may define a predicted wake trajectory utilizing at least a probability and a vector. A measurement may be made for an actual turbine wake metric (220). For instance, the actual turbine wake metric may include a wind speed measurement, a wind direction measurement, a blade root strain measurement, or other measurement. These measurements may be made by, for example, one or more lidar devices positioned at different locations within the wind plant. This measurement may be utilized to calculate a second predicted wake trajectory (230). In some embodiments, the particle filter method may calculate a second predicted wake trajectory that may be more likely to be a correct representation of the actual wake trajectory than the first predicted wake trajectory. The wind turbine plant control method may utilize the second (higher probability) predicted wake trajectory to calculate a set-point or set-point adjustment for at least one control variable for at least one of the wind plant's turbines (240). Examples of turbine control variables include at least one of pitch, yaw, and/or tilt. The new control variable set-points may then be communicated to each turbine being adjusted where the relevant control variable (e.g., pitch, yaw, tilt) may be manipulated to match the requested change from the controller. Optionally, the resultant power output from one or more of the adjusted turbines may be measured. As the wind turbine plant's environment is constantly changing, the operations of the method shown in FIG. 1 may be iterated as needed.

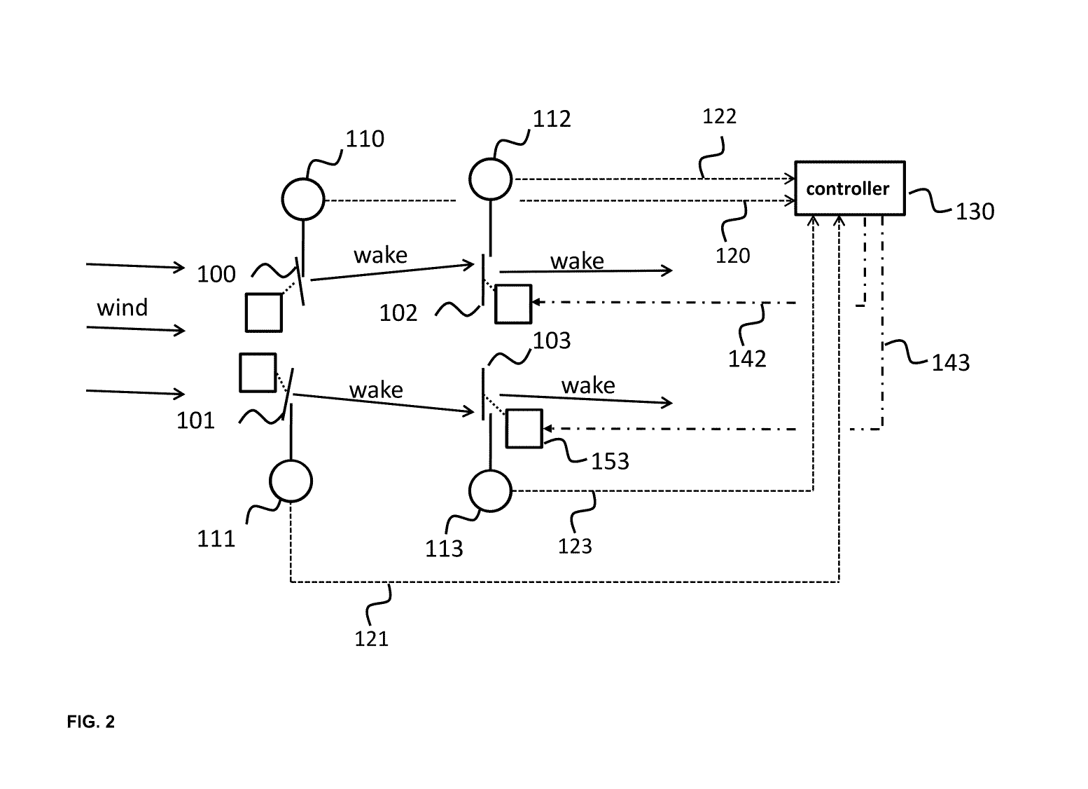

FIG. 2 is a block diagram illustrating an example wind plant control system, in accordance with one or more aspects of the present disclosure. Unwaked, prevailing winds are illustrated on the left-hand side of FIG. 2. Four turbines 100, 101, 102, and 103 are shown in the example of FIG. 2. In other examples, more or fewer turbines may be included. Each turbine may produce a wake that is directed approximately downwind (e.g., toward the right-hand side of FIG. 2). In the example of FIG. 2, turbine 102 is approximately downwind of turbine 100. Similarly, turbine 103 is approximately downwind of turbine 101.

In the example of FIG. 2, each of turbines 100, 101, 102, and 103 has at least one respective sensor 110, 111, 112, and 113 associated with the respective turbine. Sensors 110, 111, 112, and 113 may detect the local environmental conditions (e.g., wind and/or wake conditions) at the respective turbine. For example, sensors 110, 111, 112, and 113 may measure wind speed and/or wind direction and transmit these measurements as signals 120, 121, 122, and/or 123 to central controller 130 on a periodic schedule (e.g., every second, every millisecond, or at another frequency).

Controller 130 may include a computer system or device that is operable to apply a stochastic filter method to estimate wake movements as described herein. As one example, a computer system may include a data storage medium (hardware) such as RAM and a CPU for receiving, analyzing, and calculating data. In one example, the CPU may execute instructions (e.g., stored at the RAM) to perform a particle filter method. For instance, controller 130 may estimate at least one predicted wake trajectory (not shown) for at least one of turbines (100, 101, 102, and 103). Controller 130 may also receive signals 120, 121, 122, and/or 123 from sensors 110, 111, 112, and/or 113. Based on at least one actual environmental condition (e.g., the measured values in signals 120, 121, 122, and/or 123) Controller 130 may estimate a second predicted wake trajectory (not shown) for the at least one turbine. In some embodiments, the second predicted wake trajectory may be partially determined by a weighting protocol (as described below in the EXAMPLES section) that may be based at least in part on the actual wind and/or wake measurements made by sensors 110, 111, 112, and/or 113.

Based on the second predicted wake trajectory, controller 130 may then calculate set-points and/or set-point adjustment values for one or more turbine control variables. In the example of FIG. 2, only control variable 153 for turbine 103 is shown. However, in various examples equivalent control variables may exist for more or different turbines. Turbine control variables for a turbine may include the pitch, tilt, and yaw of the turbine.

Controller 130 may transmit the calculated set-points and/or set-point adjustment values as signals back to the turbines, where the set-points and/or set-point adjustment values are received. Only set-point signals 142 and 143 are shown in FIG. 1, however, set-point signals may be sent to any and/or all of the turbines in various examples. The turbine control variable or variables (e.g., turbine control variable 153) may then be manipulated to match the set-point or set-point adjustments requested by controller 130, resulting in a different turbine position and/or configuration. The turbine modification may result in a different downstream wake. For example, the sequence described above may result in the redirection of the actual wake produced by turbine 100 away from turbine 102, and the redirection of the actual wake produced by turbine 101 away from turbine 103. Consequently, the power generated by turbines 102 and/or 103 may incrementally increase, and thus the wind plant's total power production may also increase.

In some embodiments, the control system as described herein may include a storage medium and a CPU. In some embodiments, examples of a sensor as described herein may include a lidar, a cup anemometer, a propeller anemometer, a sonic device, a hot-wire device, a plate anemometer, a tube anemometer, a pitot tube, and/or a vane. In some embodiments, a measured metric associated with an actual wake trajectory may correspond to a least one of a wind speed, a wind direction, and/or a lidar measurement.

A means for communicating a set-point and/or set-point adjustment may include at least one of a wired system and/or a wireless system, or any other suitable method for communicating control set-points or other digital and/or analog signals.

In some embodiments using a particle filter method, the particle filter method may use a collection of particles. Each particle may include a state variable and an importance weight. The state variable may represent a probability of a component, such as a predicted state of a turbine wake, for example a trajectory or velocity vector. The importance weight may be determined by comparing the predicted state variable with available observations (e.g., measurements) and may represent a likelihood (or probability) that a particle is accurate given the current observations. The full set of weighted particles may be used to reconstruct an underlying probability density function.

In some embodiments, a particle filter method may be performed iteratively, such that each iteration may include: 1) a perturbation (or update) where at least one particle may be changed by either random noise and/or by sampling from a known state transition function (e.g., as described in Thrun). This may advance the particle from time t−1 (an earlier point in time) to time t (a later point in time) and may or may not include knowledge of system inputs; 2) weight updating wherein at least one importance weight of a particle may be recomputed given the latest observations (measurements); and 3) resampling where, using the weights, a new set of particles may be chosen from the existing set by choosing a replacement particle according to the particle weights (probabilities). In some embodiments, the new set of particles may describe predicted wake trajectories that have higher probabilities of matching actual wake trajectories, than the probabilities of the original set of particles.

In some embodiments, the particle filter method may be repeated at a defined time interval. Time steps may range from about every 0.1 seconds to about ever second, every minute, every hour, or other duration.

In some embodiments, a “particle” may refer to a mathematical representation of a single predicted turbine wake trajectory. In some embodiments, a particle may be defined by at least one vector and at least one probability. A particle filter method may include one or more particles representing a wake of each turbine included in the wind plant. For example, the wake of each turbine may be represented by anywhere from 1 to 10,000 individual particles or more, where each particle may represent one prediction of the wake of the turbine wake. Each particle may be defined by at least one vector and at least one probability.

Sensor measurements, such as from lidar, may be used (as further described in the EXAMPLES section below) to assign a respective weight to each particle to enable selection of at least one highest-probability predicted turbine wake trajectory. For example, at least one actual wind velocity, or a plurality of wind velocities resulting in an actual wind velocity field, may be generated based on one or more measurements made by one or more sensors positioned within the wind plant. By superimposing a wind turbine onto the at least one wind velocity or wind velocity field, the probability of each predicted wind turbine wake trajectory may be modified by a weighting factor (e.g., a multiplication factor), where the weighting factor may be at least partially defined by the actual wind velocity field. In this fashion, at least one highest-probability predicted wake trajectory may be selected for each wind turbine within the wind plant.

In some embodiments, a method for controlling the power output from a wind plant may include calculating at least one wind turbine control variable set point based on at least one highest-probability predicted wake trajectory, where a wind turbine control variable may include the pitch, yaw, and/or tilt of at least one of the wind turbines, and outputting the calculated set point, such as to a wind turbine so the wind turbine control variable can be set to the calculated set point. In some cases, the wind turbine control variable may include independent pitch control and yaw. Independent pitch control may refer to the ability to independently change the angle of each leading edge of each turbine's rotor relative to the incoming trajectory of the wind and/or wake. That is, each rotor's leading edge and angle relative to the incoming wind and/or wake may be independently controlled.

In some embodiments, a highest-probability predicted wake trajectory may be determined using a particle filter method or other stochastic filter method. The highest-probability predicted wake trajectory may be utilized by a wind plant operator and/or automated control system to predict which downstream turbines are more likely to lie in the flow-path of a predicted wake trajectory. A predicted wake trajectory may provide information needed to provide control adjustment settings for at least one upstream turbine to minimize detrimental wake effects on at least one downstream turbine. For example, if an upstream turbine is creating a wake that is directly impinging the rotors of a downstream turbine, as identified by a highest-probability predicted wake trajectory that intersects the rotors of the downstream turbine, thus reducing its ability to capture wind energy, a control system may provide at least one correction to at least one of the pitch, yaw, or tilt of an upstream turbine, such that the actual wake of the upstream turbine may be directed away from the downstream turbine. As a result, the total power output from both the upstream and the downstream turbines may be increased.

A further aspect of the present disclosure is a stochastic filter method for controlling the power output from a wind plant that controls and/or manipulates the control variables of at least one wind turbine in the plant by utilizing a control system. A control system may use a stochastic filter method's turbine wake predictions and sensor measurements of actual environment conditions (e.g., wind speed, wind direction, etc.) to provide control setting adjustments or set-points for yaw, tilt, and/or pitch of at least one wind turbine, with the control objective being optimization (for example maximizing) of the wind farm's total wind capture and/or power output. Process control strategies that may be used in conjunction with the stochastic filter methods described herein to control the wind plant power output include, but are not limited to, traditional feedforward control or feedback control that utilize at least one of proportional, integral, or derivative parameters. More sophisticated control strategies that may be used in some embodiments include, but are not limited to, fuzzy logic controllers, model-based controllers, intelligent control algorithms, neural networks, control methods that utilize chaos theory, and combinations thereof. Control strategies for controlling the power output from a wind plant may also include models based on first principles, empirical equations, heuristic relationships, steady-state and/or dynamic behavior, as well as linear and/or non-linear behavior.

In some embodiments, a historical database may be generated over time. The database may store the preferred settings of turbine control variables (e.g., pitch, yaw, and/or tilt) that correlate to corresponding sensor measurements, and predicted turbine wake trajectories. Periodically as the stochastic filter method provides wake trajectory estimates, a global picture of the wind plant may be generated. This global picture may then be compared to past global pictures stored in the database, where each stored global picture also has an optimum set of turbine orientations (e.g., pitch, yaw, and/or tilt) associated with it for each of the turbines in the wind plant, such that a turbine arrangement may be defined by the various turbine control variables (e.g., pitch, yaw, and tilt). In some embodiments, the control system for predicting wake trajectories may include a machine learning algorithm that accepts as inputs at least one of the particle filter's predicted wake trajectories, sensor measurements, control variable set-points (e.g., for pitch, tilt, and yaw), individual turbine power production rates, and combinations thereof. The machine learning algorithm may then utilize these inputs to provide better control variable set-points in response to later changes or disturbances to the wind plant's atmospheric environment.

As the atmospheric environment encompassing the turbines of a wind farm is dynamic, a control system and a control algorithm or process for controlling the turbine control variables should be responsive in a time-scale that is fast enough for the set-point changes to have a meaningful impact on both an individual turbine's power output as well as on the wind plant's total power output. Therefore, the control systems described herein, making use of stochastic filter methods may be defined by a characteristic iteration rate. Additionally, the sensors providing real environmental conditions to the control system may be defined by a characteristic sampling rate, and the controller may be defined by a characteristic communication rate for sending set-point adjustments to the control variables.

One aspect of the present disclosure provides a computational method that utilizes a stochastic filter. The method may include receiving at least one metric from a sensor, estimating a predicted wake trajectory corresponding to an actual wake trajectory, and calculating a wind turbine control variable set point based on the estimated wake trajectory.

In some embodiments, a particle filter method may be used to estimate the predicted wake trajectory. The particle filter method may define at least one predicted wake trajectory by assigning the predicted wake trajectory a vector and a probability. In some embodiments, a vector describing a wake trajectory may include at least one segment length, at least one angle, at least one intersection distance, or a combination thereof.

The particle filter method may include introducing a perturbation to a probability. A perturbation may, in some examples, represent a combination of a known control actuation and noise. Alternatively, unknown forcing may be used. In the case of unknown forcing, no knowledge of what affects the particles is assumed and a random perturbation may be applied.

The output of the particle filter method may be, for instance, at least one estimated wake location or trajectory. This output may be coupled with wind plant control techniques, such as modified axial induction or wake redirection, to form a complete closed-loop control system within the random and unknown environment of a wind turbine plant. This may result in a wind turbine control method or system that optimizes the power capture and output for the wind plant, even in the presence of dynamically changing weather and wind conditions. In some embodiments, wind plant or wind turbine control techniques for wake redirection may include manipulating a turbine's yaw and/or tilt, while simultaneously applying independent pitch control (IPC) to, among other things, reduce loading impacts. In various examples, any number of wind turbine control techniques may be used, such as those provided by the following publications which are incorporated herein by reference in their entirety: “Evaluating techniques for redirecting turbine wakes using SOWFA”, Renewable Energy (2014), DOI: 10.1016/j.renene.2014.02.015; and “Simulation comparison of wake mitigation control strategies for a two-turbine case”, Wind Energy (2014), DOI: 10.1002/we.1810.

Some embodiments of the particle filter methods described herein may also include resampling. Resampling is the process of choosing a new set of particles from a currently weighted sample. The main idea is to remove from consideration the least weighted or lowest probability particles and focus on the highest weighted or highest probability particles. This causes the particle filter to concentrate the search in the most likely sectors of the space and probability density function, and helps the particle filter operate with a reduced number of particles, which results in, among other things, faster calculation times.

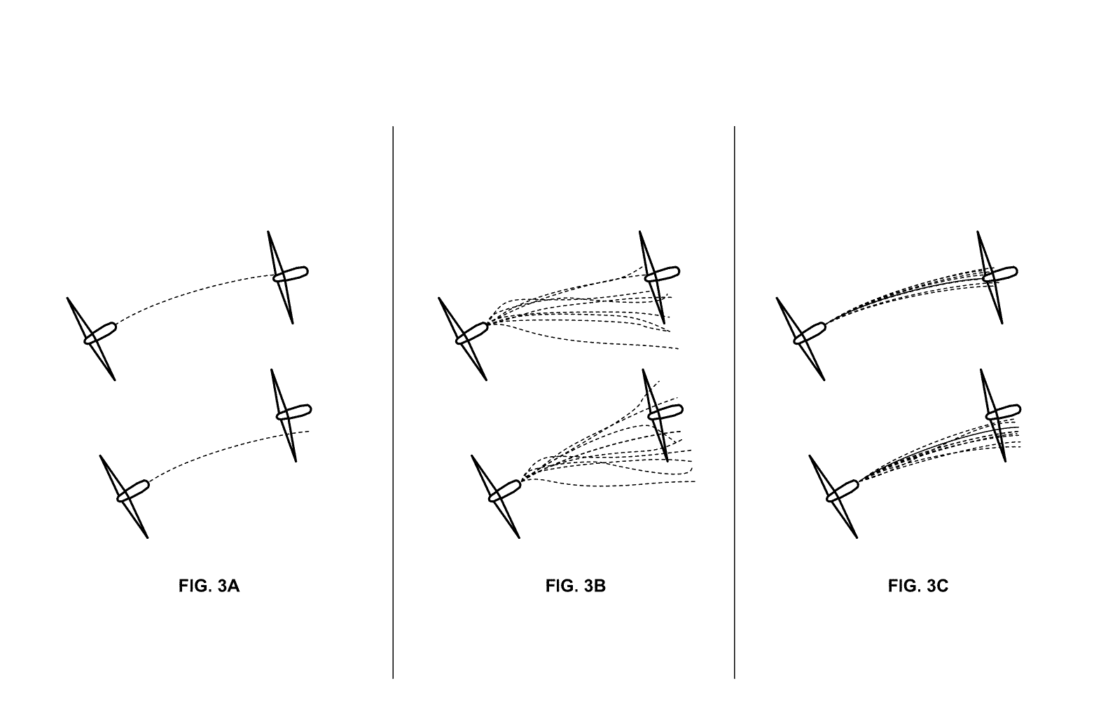

In some embodiments, particle filters may be used for wake prediction and/or estimation, in which a single particle may be an estimate of the trajectory of the wake for each turbine in the wind plant. The particle filter may be composed of N particles where N ranges from 1 to 100 million or more. A measurement may include the combined sensor data from all turbines, which may be used to assign a weight to each particle. In some embodiments, at least one sensor measurement may be used to assign a weight to at least one particle. In still further embodiments, from about 1 to 1000 sensor measurements or more may be simultaneously utilized by the particle filter system or method. This concept is illustrated in FIG. 3.

In the example of FIGS. 3A-3C, each particle may include one wake trajectory per turbine, as seen in FIG. 3A. A particle filter may include many different individual particles, as shown in FIG. 3B. At each time step, the particles may be perturbed, weighted, and resampled as described herein. Eventually, particles may tend to cluster in the most highly weighted regions, as shown in FIG. 3C. In the example of FIGS. 3A-3C, a single representative particle may be obtained using the particle filter. For instance, the particle represented by the solid line in FIG. 3C may be determined as the representative particle. In some examples, two or more representative particles may be obtained.

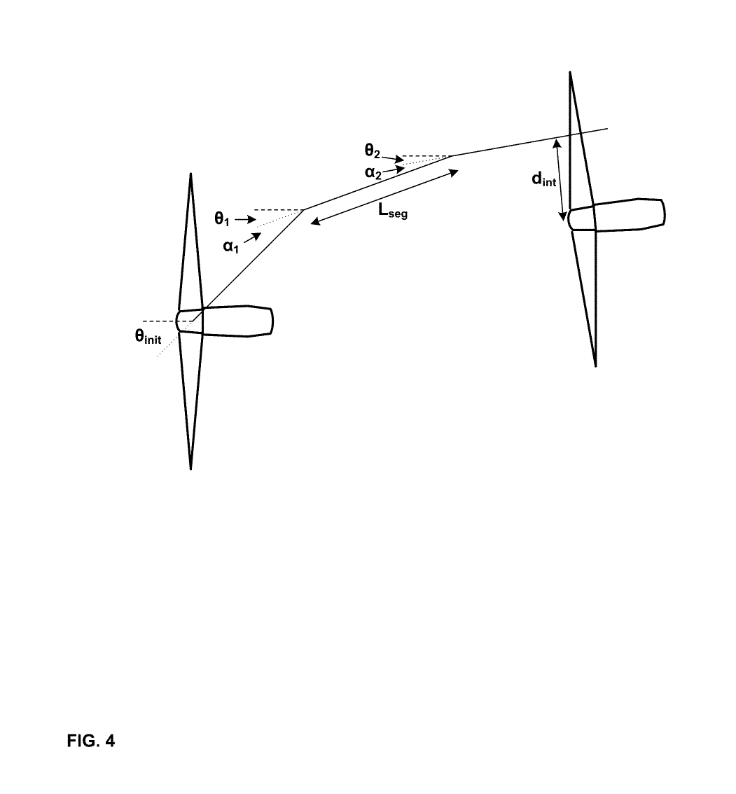

Having defined that the particle filter may be composed of one or more particles and each particle may be composed of at least one wake trajectory per turbine, a structure of each wake trajectory may be defined. This is shown in FIG. 4, which illustrates that a single trajectory may be composed of several joining line segments. The trajectory may be defined by several values, some of which may be constant, such as the number of segments and segment lengths. These may be uniform across all trajectories. Others variables may vary with each perturbation step, for example the initial angle of the trajectory and the angles between segments. Finally, values such as the angle between each segment and the horizontal, may be calculated values and used in weighting a particle. Some exemplary values are summarized in Table 1.

Although FIG. 4 illustrates the predicted wake trajectories in two-dimensional space, some embodiments may also include wake estimation in three-dimensional space.

TABLE 1
Definition of parameters that define a trajectory with a particle.
In this example, each particle includes one trajectory for each
upstream turbine.

| Type | Variable | Description |
|---|---|---|
| Static | L_{seg} | Segment length |
| | N_{seg} | Number of segments |
| Variable | α_{1, 2 . . . , N}_{_{seg}}₋₁ | Angle between segments |
| | θᵢₙᵢₜ | Initial angle between wake and horizontal |
| Derived | θ_{1, 2 . . . , N}_{_{seg}}₋₁ | Angle at joint to horizontal |
| | dᵢₙₜ | Intersection distance |

At each time step, each particle may be perturbed to generate a new set of set of particles. In some embodiments, this perturbation may be applied to θᵢₙᵢₜ, the initial angle between the wake and horizontal, and to each of the joint angles α_{1, 2, . . .} . The amount of perturbation may be selected from a normal distribution with a standard deviation of 2 degrees, or from a non-normal distribution characterized by some other relevant parameter.

Weighting of the particles may be accomplished by comparing a particle state with available measurements from sensors (e.g., that are mounted on the wind turbines). For example, wind and/or wake data (e.g., wind speed measurements, wind direction measurements, etc.) may be available from sensors such as anemometers, vanes, lidar systems, and/or blade root strain sensors. In various examples, additional or other sensor information may be used to fine tune the weighting results. For instance, additional sensor data may include indications of which side of a rotor a wake is impacting.

Combining sensor measurements may provide several ways in which the weighting of a particle's probability may be assessed. In some embodiments, a weighting strategy may define separate subweights for a particle, such that each subweight may define a “penalty” where a larger weight may be assigned for a less likely particle (e.g., wake trajectory). When each subweight is computed, the weights may be totaled after being scaled by a scaling parameter that corresponds to the importance of each subweight. Selection of these scaling parameters may be done manually or in an automated fashion. Scaling parameters may be selected to assure that no single subweight dominates. The total weight may be inverted, so that the largest weighted particle may be the most probable representation of the actual wake trajectory.

The techniques of the present disclosure may be more readily understood by reference to the following examples, which are included merely for the purposes of illustration of certain aspects of the embodiments. These examples are not intended to be limiting, and one of skill in the art will recognize from the above teachings and the following examples that other techniques and methods may fall within the scope of the claims herein.

### Example A

An example of how separate subweight computations may be performed follows below. Note that in this example, when a weighting function applies to a single wake trajectory, the total subweight value may be the sum of a computed penalty (described below) for each trajectory in the particle.

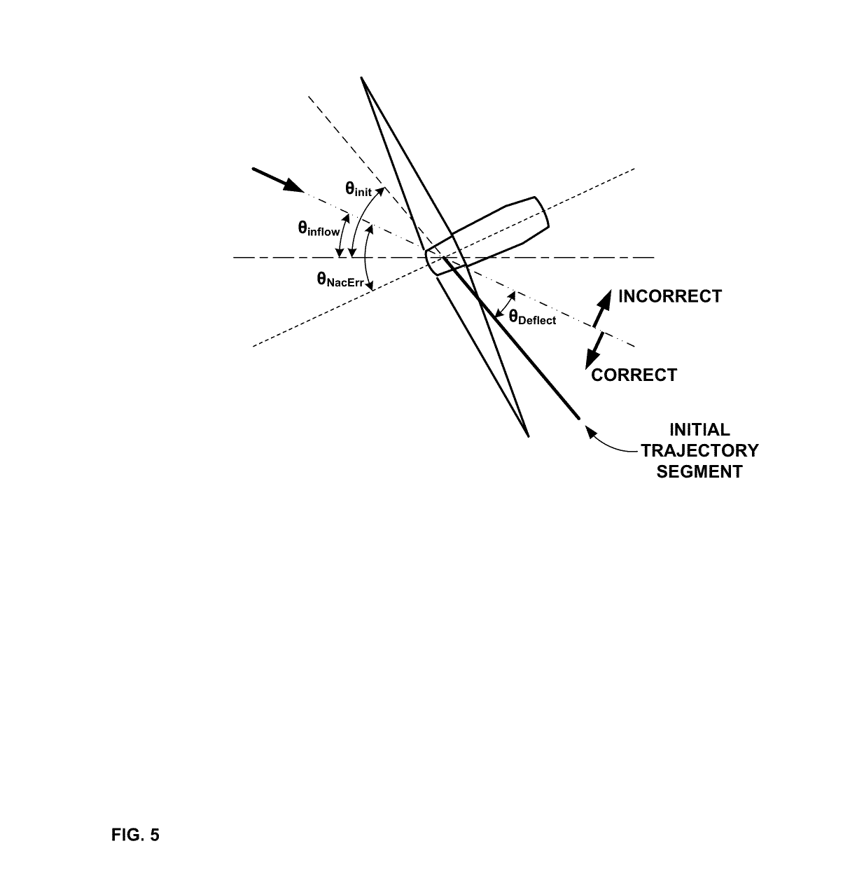

Deflection: In this example method of a subweight computation, a first subweight is meant to penalize an initial wake angle (θᵢₙᵢₜ), which conflicts with assumptions about the relationship between yaw misalignment and the deflection of the wake with respect to the inflow direction. An assumption is made that the direction of the deflection is consistent across turbines, however, as illustrated in FIG. 5.

Referring to FIG. 5, θ_{inflow} is defined as the angle of the inflow angle with respect to a reference axis shown as a short then long dashed horizontal line in FIG. 5, while θ_{NacErr} is defined as the angle between the yaw alignment of the turbine with respect to the inflow direction. θᵢₙᵢₜ is defined as the initial angle of a given particle with respect the horizontal reference axis. Finally, θ_{Deflect} is defined as the angle between θᵢₙᵢₜ and θ_{inflow} and represents the particle's prediction of the deflection angle. In this example, a weighting is assigned based on a model-predicted θ_{Deflect}. However, as another example, a simple generic weighting may apply no penalty if the deflection is in the correct angle, and may apply an increasing penalty when the deflection is in the incorrect direction. Another exemplary weighting rule may be that if θ_{NacErr} is somewhat small, no weighting is applied in any case as the deflection may be small relative to random variation. θ_{NacErr} is measured by individual turbines, and θ_{inflow} is computed by combining θ_{NacErr} with the known yaw angle of the upstream turbines. Both signals are filtered using a recursive filter with a 2 second time constant to reduce the effects of noise. This yields the following exemplary weighting algorithm:

if abs(θ_{NacErr} < 5) then W_{Deflect} = 0

else if sign(θ_{NacErr}) 6 ≠ sign(θ_{Deflect}) then

W_{Deflect} = abs(θ_{NacErr}) + abs(θ_{Deflect})

else
W_{Deflect} = 0

end if

Tail alignment: This subweight may be used to penalize particles in which the “tail” of the particle, or furthest downstream segments, is not aligned with the free-stream direction. This exemplary weight is formulated as:

$${W}_{tail} = {\sum }_{i = \frac{{N}_{seg}}{2}}^{{N}_{seg} - 1} {( \frac{i}{{N}_{seg} - 1} )}^{2} abs ( {θ}_{i} - {θ}_{inflow} )$$

Note that in this example, the penalty increases as the segments progress downstream.

Intersection: An important mechanism for weighting a given particle, described by a wake trajectory for each turbine, may include weighting how well the particle explains the waking encountered at each downstream turbine. An exemplary method for accomplishing this may include: 1) Defining that a downstream turbine is waked if its local wind speed measurement is some threshold less than the “freestream” velocity, where the freestream velocity may be computed as the mean of one or more upstream turbine velocities, and 2) Identifying a waked downstream turbine by determining that one or more wake trajectories may be intersecting a rotor of the downstream turbine. “Freestream” velocity refers to the naturally occurring “unwaked” airflow or wind.

Given the above, the value d_{Int} for a given particle and given downstream turbine may be defined as the distance along the rotor to the nearest intersection of a wake trajectory along the rotor plane, as shown in FIG. 4. A subweight scheme may be applied that assumes that if the turbine is waked, the intersection should be within the turbine radius (R). Similarly, if the turbine is not waked—that is the local velocity is close to the free-stream velocity—as determined by the upstream turbines, d_{Int} may be ideally larger than R. Finally, if the differential between the local inflow speed is such that waking is ambiguous, no weighting may be applied.

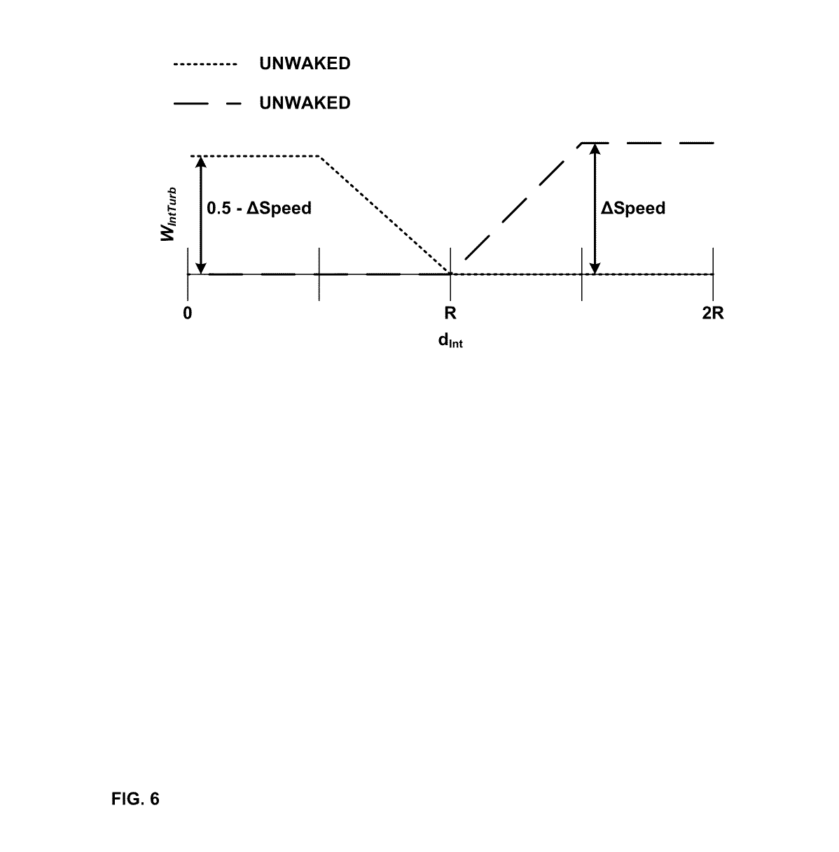

For waked and unwaked cases, an example of a per-turbine weighting scheme for intersection is illustrated in FIG. 6. Note that the amount of weighting may be conditioned by the degree of waking or nonwaking observed, which may be represented by the delta speed value between local inflow and plant inflow computed by the upstream turbines. The intersection penalty may be computed for each turbine (W_{IntTurb}), and the sum across all turbines may be equated to an intersection penalty (W_{Int}).

Intersection location: In this example, subweighting may utilize blade root strain gauge measurements to maximize the use of potentially available sensors. So, when available, all blade measurements may be combined to compute a yawing moment observed at the rotor that gives an indication of which side of the rotor the wake is more likely to be impacting. This in turn may be used to penalize particles with wake intersections on the side of a rotor less likely to be correct. A subweight of zero may be assigned if a turbine has no intersecting trajectories or if the nearest trajectory is on the correct side. Alternatively, if the nearest intersecting trajectory is on the wrong side, then a subweight may be applied maximally when the wake appears to be centered at the radius and dropping off in both directions. The intersection location penalty (W_{IntLoc}) may be the sum of the penalties computed for each turbine.

Straightness and smoothness: Two final weights penalize particle trajectories that are not straight:

$${W}_{straight} = {\sum }_{i = 1}^{{N}_{seg} - 1} abs ( {α}_{i} )$$

And trajectories that are not smooth:

$${W}_{smooth} = {\sum }_{i = 2}^{{N}_{seg} - 1} abs ( {α}_{i} - {α}_{i - 1} )$$

In some embodiments, these weights may be given lower priority than the weights based on sensor measurements. The purpose of these weights may be to apply these weights when a straighter and smoother wake trajectory is more likely.

A final step performed in this exemplary particle filter method is the selection of a single “representative particle” from the full set of particles. This may be done in several ways. Selecting the highest weighted (most probable) particle and computing a weighted average are two possible solutions. However, in the case of wake predicting in a wind plant, the highest weighted particle may lead to too noisy of a signal, as the highest weighted particle might jump significantly from time step to time step. Weighted averaging may also be problematic, because in a multimodal case, such as trajectories clustered on either side of a downstream turbine, the average might split the difference and lead to a very low probability estimate. So, in some embodiments, identifying the best representative particles may involve selecting the highest weighted particle and then averaging the k-nearest particles. For example, k may be defined as 10% of the total number of particles.

### Example B

Based on the features described above, a particle filter method was tested to determine the method's capabilities at predicting wind plant turbine wake locations. This testing was enabled by the use of a high fidelity wind plant simulation tool developed at the National Renewable Energy Laboratory (NREL): the Simulator for Onshore/Offshore Wind Farm Applications (SOWFA). Within SOWFA, several wind plant scenarios were carried out, utilizing virtual turbine measurements (such as nacelle wind speed, wind direction, and blade bending), and these computational fluid dynamic (CFD) outputs were used to run the particle filtering method described above. In addition, horizontal slices from the flow-field at hub height were extracted, in which turbine wakes are clearly visible and provide a way to evaluate the performance of the particle filter technique.

Regarding the simulation tool utilized for the following experiments, SOWFA is a CFD tool used to model wind turbines in a flow field. It couples NREL's FAST turbine modeling tool, with a CFD solver based on the OpenFOAM toolbox. The CFD solver uses a large-eddy simulation method to resolve the larger turbulent scales to simulate the atmospheric boundary layer where wind turbines are located. This flow is first created using the CFD solver alone to generate a free-flowing field without the influence of the wind turbines. Once this is done, the inflow is saved to be used with the wind turbines. The wind turbines are modeled using an actuator line technique coupled with FAST, where a rotating model of the wind turbine's rotor is used to create time-dependent forces in the flow that generate wakes that interact with each other as well as with the flow itself. Each blade is represented by a line broken into segments. Each segment has a known airfoil type, twist angle, and chord length. The velocity from the flow field is then used as a local inflow to the blade segment, and corresponding lift and drag tables are then used to determine the force vector at each segment. This force vector is then projected onto the flow-field as volumetric body forces to model the turbine's interaction with the wind flow. For control, each turbine can operate an individual controller, and an overarching wind plant controller can also be implemented. For producing measurements, the nacelle wind speed and direction measurements are captured from the simulation via a probe in the flow located at each turbine nacelle, and the blade-bending is returned by each turbine FAST instance.

As one example test of the techniques described herein, a wake estimation technique using a particle filtering technique in accordance with the techniques described herein was applied to a simulated wind farm constructed of two rows with three NREL 5-MW baseline turbines, with a 5-rotor-diameter spacing in the down-wind direction, and 3 rotor diameters in the cross-wind direction. This setup was placed in a 3-km (length) by 3-km (width) by 1-km (altitude) mesh. The smallest mesh cells, which contained the turbine rotors, the axial induction zones of the rotor, and the wakes between the turbines, had a size of 3 m×3 m×3 m. Farther away from the turbines, the mesh was coarsened to 6 m×6 m×6 m cells, then to 12 m×12 m×12 m cells, resulting in a total of 32×10⁶ cells. Using a time step of 0.02 seconds, a 1000 second simulation was performed. This simulation took about 59 hours to perform using distributed computation with 512 processors. The setup was subjected to a turbulent inflow with a 6% turbulent intensity and an 8 meter per second mean velocity at hub height.

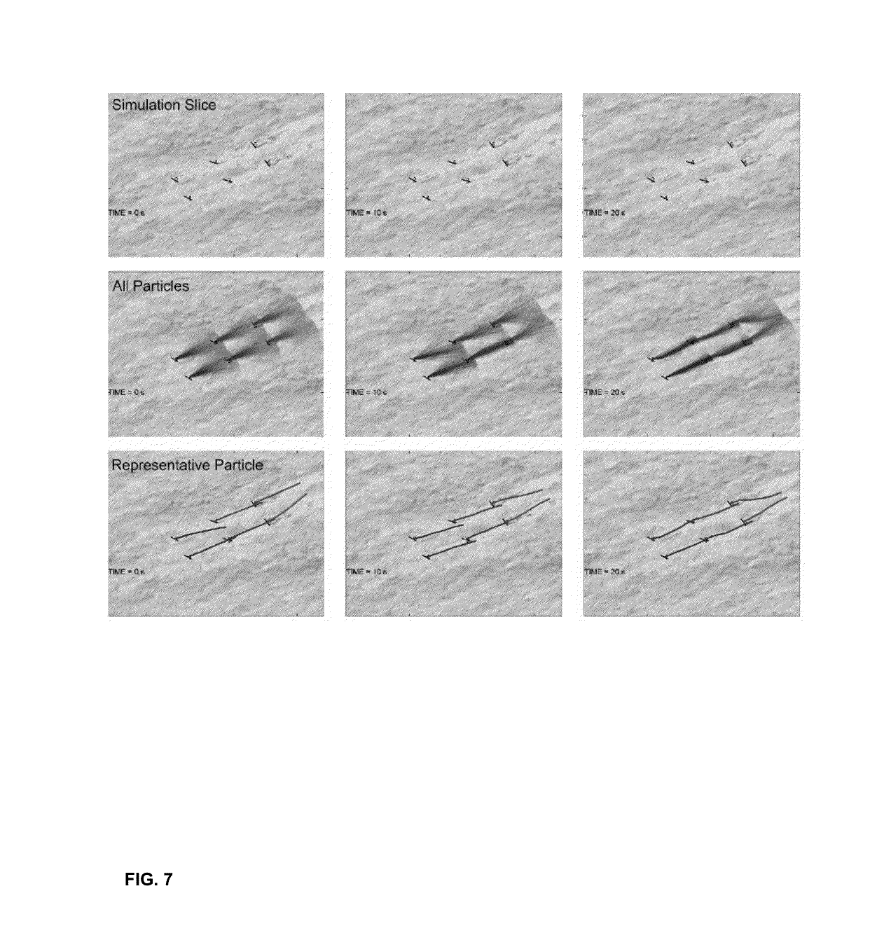

FIG. 7 shows the results of one simulation and method. The plots of FIG. 7 represent a case where the wind turbine rows were aligned with the mean 300° flow direction. The mean flow direction for these simulations was nonvarying. Further, cases were evaluated where the rows were rotated 5°, 10°, and 15° relative to the wind direction.

One wake estimation system detailed herein was then applied to a case where the turbine rows were aligned with the flow. Some of the turbines, however, were yawed in a way to redirect their wakes. The results from the particle filter at several time steps are overlaid on the flow-field in FIG. 7. Note that although the simulation was run with a time step of 0.02 seconds, the particle filter was run at 1 second given the time scales of wake propagation and meandering. FIG. 7 shows the evolution of the particle filter with time in the middle row, as well as the selected representative particle for each time step in the bottom row. The correspondence with the wake location is good, and the wake estimation appears able to cover the range of possible locations, as well as choose a reasonable best estimate.

The middle row of FIG. 7 shows that for the turbine whose wake impacts a downstream turbine, it is possible to narrow the search space, whereas turbines at the end of the row have more uncertainty as to the final wake location. This difference in certainty relating to whether or not a downstream turbine is present impacts the correctness of the overall wake estimation (shown in the bottom row as the representative particle).

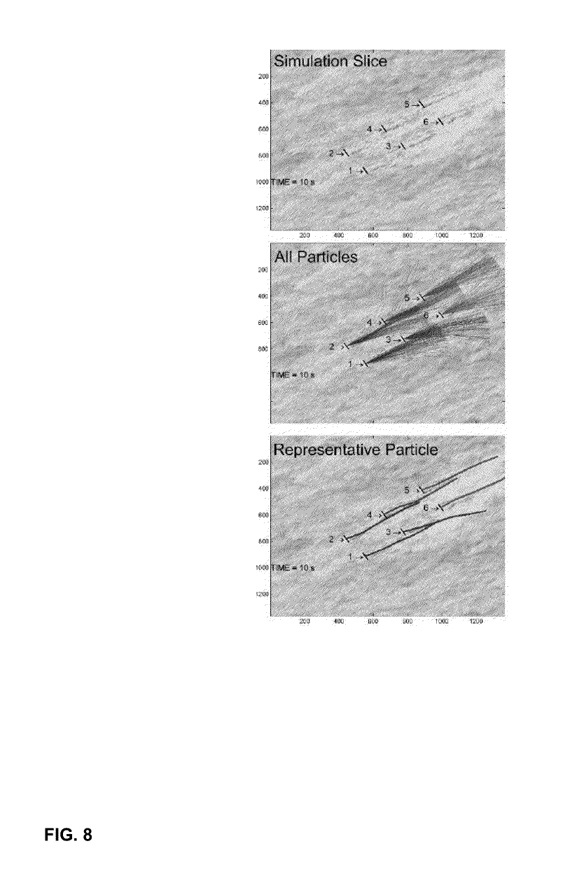

FIG. 8 illustrates a single time step from a simulation where the turbine rows were aligned 10 degrees off the inflow direction, leading to partial overlap only. FIG. 8 also gives insight into how a particle filter performs in a wind plant application or setting. Notice that the trajectories of turbine 4 are more compactly spaced than the trajectories of turbine 3. Turbine 6 is currently unwaked, and the range of probable trajectories is larger given that no turbines are downwind of turbine 6. As a final point, note that among the trajectories of turbines 1, 2, 3, and 4, the vast majority go “below” the respective downstream turbine, while relatively few go “above” (technically south and north, respectively). This is an excellent feature of particle filters: the most effort is placed in the highest probable (and it turns out correct region) of the space, but some small search is made of another improbable, but not impossible, space.

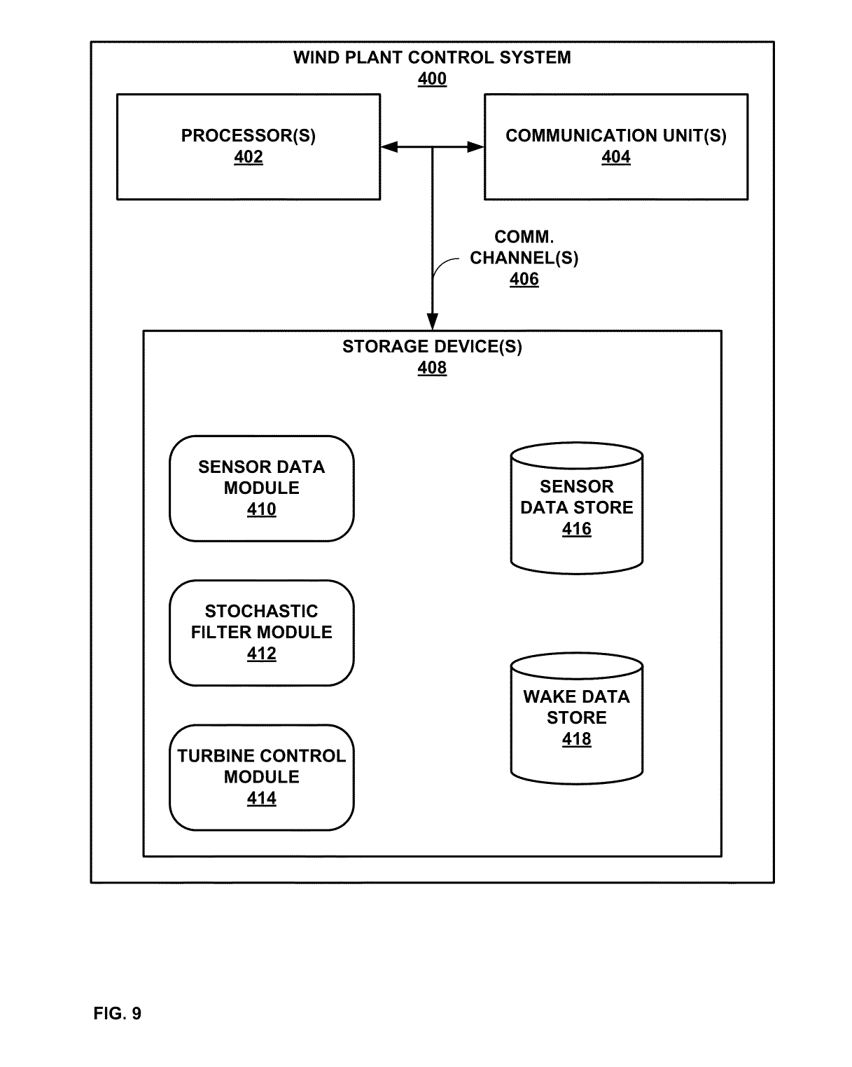

FIG. 9 is a block diagram illustrating an example wind plant control system (wind plant control system 400), in accordance with one or more aspects of the present disclosure. In the example of FIG. 9, wind plant control system 400 is shown as a single device. However, FIG. 9 illustrates only one particular example of a wind plant control system, and wind plant control system 400 may, in various examples, consist of multiple interconnected devices, such as a server system or “cloud” computing system in other instances.

As shown in the specific example of FIG. 9, wind plant control system 400 includes one or more processors 402, one or more communications units 404, and one or more storage devices 408. Storage device 408 include sensor data module 410, stochastic filter module 412, turbine control module 414, sensor data store 416, and wake data store 418. Each of processors 402, communications units 404, and storage devices 408 may be interconnected (physically, communicatively, and/or operatively) for inter-component communications. In the example of FIG. 9, for instance, processors 402, communications units 404, and storage devices 408 are connected by one or more communications channels 406. Examples of communications channels 406 may include a system bus, a network connection, an inter-process communication data structure, or any other channel for communicating data. Modules 410, 412, and 414, as well as sensor data store 416 and wake data store 418 may also communicate information with one another, as well as with other components in wind plant control system 400.

Processors 402, in one example, are configured to implement functionality and/or process instructions for execution within wind plant control system 400. For example, processors 402 may be capable of processing instructions stored in storage devices 408. Examples of processors 402 may include any one or more of a microprocessor, a controller, a digital signal processor (DSP), an application specific integrated circuit (ASIC), a field-programmable gate array (FPGA), or equivalent discrete or integrated logic circuitry.

One or more storage devices 408 may be configured to store information within wind plant control system 400. For instance, storage devices 408 may be used to store program instructions for execution by processors 402. That is, storage devices 408, in some examples, may be used by software or applications running on wind plant control system 400 (e.g., modules 410, 412 and/or 414) to temporarily store information during program execution.

Storage devices 408, in some examples, may represent computer-readable storage media. For instance, storage device 408 may be configured to store relatively larger amounts of information and/or may be configured for long-term storage of information. In some examples, storage devices 408 include non-volatile storage elements. Examples of non-volatile storage elements include magnetic hard discs, optical discs, floppy discs, flash memories, or forms of electrically programmable memories (EPROM) or electrically erasable and programmable memories (EEPROM).

In some examples, storage devices 408 may represent a temporary memory, meaning that a primary purpose of storage devices 408 is not long-term storage. For instance, storage devices 408, in some examples, can be described as a volatile memory, meaning that storage devices 408 do not maintain stored contents when power to storage devices 408 is turned off. Examples of volatile memories include random access memories (RAM), dynamic random access memories (DRAM), static random access memories (SRAM), and other forms of volatile memories known in the art.

In the example of FIG. 9, wind plant control system 400 may utilize communication units 404 to communicate with external devices via one or more networks. Examples of communication units 404 may include a network interface card, such as an Ethernet card, an optical transceiver, a radio frequency transceiver, or any other type of device that can send and receive information. Other examples of such network interfaces may include Bluetooth, 3G and WiFi radio components as well as Universal Serial Bus (USB). In some examples, wind plant control system 400 may utilize communication units 404 to communicate with external devices such as turbines 100, 101, 102, and 103 or sensors 110, 111, 112, and 113 as shown in FIG. 2, or other devices.

In some examples, wind plant control system 400 may contain additional or components than those shown in FIG. 9. For instance, wind plant control system 400 may contain one or more input devices—such as devices configured to receive input from a user through tactile, audio, or video feedback—one or more output devices—such as devices configured to provide output to a user using tactile, audio, or video stimuli—and/or other components.

In the example of FIG. 9, sensor data store 416 may include data from sensors of the wind plant. For instance, sensor data store 416 may receive and store data from sensor data module 410. The sensor data stored in sensor data store 416 may be used by one or more other components of wind plant control system 400 to determine predicted wakes for the wind plant and/or determine wind turbine control variables for turbines of the wind plant. Sensor data store 418 may represent a data structure. For instance, sensor data store 418 may represent an array structure, a list structure, a text file, a database (e.g., a relational database, a multi-dimensional database, or another database structure), or other data structure suitable for storing sensor data.

Wake data store 418, as shown in the example of FIG. 9, may include data representing predicted wakes of the wind farm. For instance, wake data store 418 may receive and store data received from stochastic filter module 412. The data stored in wake data store 418 may be used by one or more other components of wind plant control system 400 to determine wind turbine control variables for turbines of the wind plant. Wake data store 418 may represent a data structure, such as an array, a list, a text file, a database, or any other data structure suitable for storing wake data.

In the example of FIG. 9, sensor data module 410 may be operable by processors 402 to receive and process sensor data and store the sensor data in sensor data store 416. For instance, sensor data module 410 may receive sensor data from communications units 404 (e.g., as transmitted by sensors of the wind plant). Sensor data module 410 may process the sensor data by organizing and/or categorizing the data for use in generating predicted wake trajectories. For example, sensor data module 410 may format the data for addition to a database, add a timestamp to the data, tag the data with an indicator of the respective sensor that generated the data, or perform other processing. In some examples, sensor data module 410 may receive raw sensor data and convert the raw sensor data into relevant sensor measurement values. Sensor data module 410 may store the sensor data in sensor data store 416.

Stochastic filter module 412, in the example of FIG. 9, may be operable by processors 402 to generate a prediction of one or more wake trajectories of turbines in the wind plant. For instance, stochastic filter module 412 may access sensor data store 416 to retrieve sensor data, and use a stochastic filter to generate wake trajectory predictions as described herein (e.g., using a particle filter, a Kalman filter, or another stochastic filter). Stochastic filter module 412 may store data representing wake trajectory predictions in wake data store 418.

In the example of FIG. 9, turbine control module 414 may be operable by processors 402 to specify and/or modify wind turbine control variables based on predicted wake trajectories. For example, turbine control module 414 may access wake data store 418 to retrieve predicted wake trajectories, and determine, based on the predicted wake trajectories, optimal turbine control variables. Turbine control module 414 may output (e.g., via communications units 404) turbine control variables for use by turbines of the wind farm.

In this way, wind plant control system 400 may intelligently control the turbines of a wind farm by applying stochastic filters to real sensor data to generate predicted wake trajectories and modify turbine control variables to achieve improved power generation. Using stochastic filters as described herein may provide more accurate, near-real-time monitoring and control of wind plant operation while reducing or even obviating the need for sophisticated sensors and processing abilities.

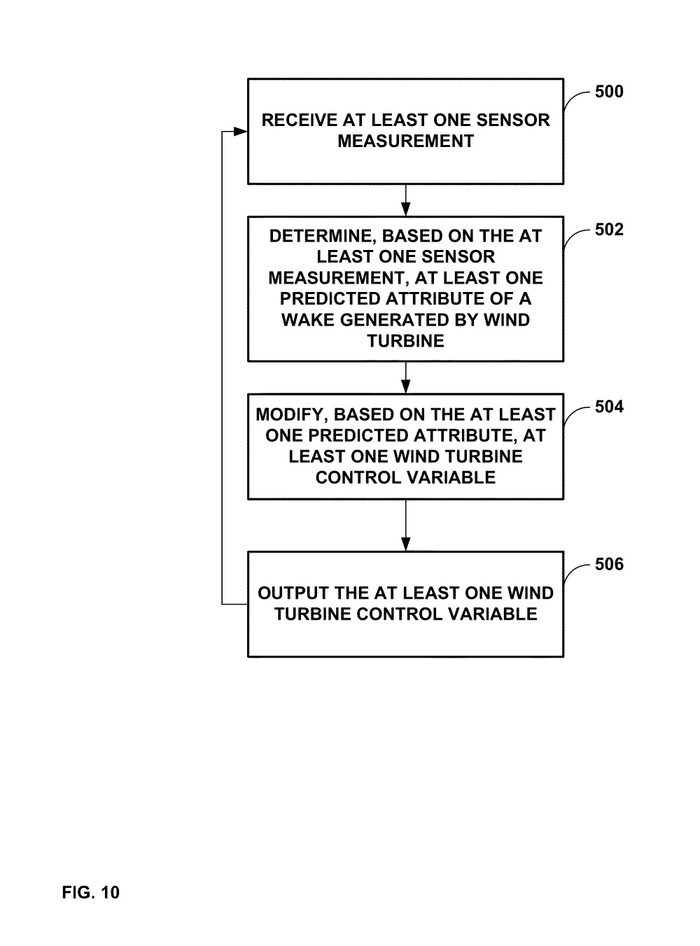

FIG. 10 is a process diagram illustrating an example method for wind plant control, in accordance with one or more aspects of the present disclosure. FIG. 10 illustrates the operation of one particular example process, and many other possible processes may be used in accordance with the techniques described herein. For purposes of illustration only, the example process shown in FIG. 10 is described within the context of wind plant control system 400, as shown in FIG. 9.

In the example of FIG. 10, a computing system (e.g., wind plant control system 400) may receive at least one sensor measurement (500). For instance, communications units 404 may receive sensor measurements from sensors mounted to wind turbines in the wind plant and transmit the sensor measurements to sensor data module 410 for processing. In some examples, the at least one sensor measurement may include at least one of a wind speed measurement, or a wind direction measurement.

Wind plant control system 400 may determine, based on the at least one sensor measurement, at least one predicted attribute of a wake generated by a wind turbine (502). The wind turbine may be one of a plurality of wind turbines of a wind plant controlled by wind plant control system 400. Wind plant control system 400 may determine the at least one predicted attribute using a stochastic filter. For instance, stochastic filter module 412 of wind plant control system 400 may obtain sensor data from sensor data module 410 and/or sensor data store 416 and use the sensor data to generate one or more predicted wake trajectories. Wind plant control system 400 may then determine at least one predicted attribute using the predicted wake trajectories.

In the example of FIG. 10, wind plant control system 400 may modify, based on the at least one predicted attribute of the wake, at least one wind turbine control variable for at least one wind turbine of the plurality of wind turbines (504). For instance, turbine control module 414 may modify a yaw, pitch, or tilt variable for one or more turbines in order to improve the overall electricity generation of the wind farm. Wind plant control system 400 may output the at least wind turbine control variable (506). For instance, turbine control module 414 may send data to communications units 404 for output, such as to wind turbines of the wind park. The wind turbine control variables may be useable by a receiving wind turbine to modify its configuration accordingly.

In one aspect of the present disclosure, a particle filter method controls power output from a wind turbine plant that includes a plurality of wind turbines. The method may include predicting a first wake trajectory resulting from a first turbine, where the first predicted wake trajectory is described by a first vector and a first probability and measuring a metric associated with a first actual wake resulting from a second turbine. Based on the measured metric, the method may calculate a second predicted wake trajectory resulting from a third turbine, where the second predicted wake trajectory is described by a second vector and a second probability. Based on the second predicted wake trajectory, the method may adjust a wind turbine control variable for a third turbine, where the first turbine, the second turbine, and the third turbine may all be the same turbine, may all be distinctly different turbines, or a combination thereof.

In some embodiments of the present disclosure, the predicting may include introducing a perturbation to the first probability. In some embodiments, the first vector may be described using at least one segment length, at least one angle, and at least one intersection distance. A wind turbine control variable may include a pitch, a yaw, or a tilt. A measured metric may include a wind speed, a wind direction, or a lidar measurement.

In another aspect of the present disclosure, a particle filter system may control power output from a wind turbine plant, where the system includes an upwind turbine, where a first orientation of the upwind turbine is defined by at least one of a first pitch, a first yaw, or a first tilt. The system may also include a downwind turbine, arranged downwind of the upwind turbine, where a second orientation of the downwind turbine is defined by at least one of a second pitch, a second yaw, or a second tilt. In addition, the system may include a sensor for measuring at least one metric associated with an actual wake trajectory downwind of the upwind turbine, and a control system including a memory and a processor coupled to the memory. The processor may be defined by calculation logic that calculates a first predicted wake trajectory for at least one of the upwind turbine or the downwind turbine, where the first predicted wake trajectory is based on a perturbation. The processor may also include calculation logic that calculates a second predicted wake trajectory for at least one of the upwind turbine or the downwind turbine, where the second predicted trajectory is based on the first predicted wake trajectory and a measurement received from the sensor. In addition, the processor may include calculation logic that calculates a set point corresponding to a setting for at least one of the first pitch, first yaw, first tilt, second pitch, second yaw, or second tilt.

In some embodiments, a particle filter system may include a means for communicating the set point to at least one of the upwind turbine or the downwind turbine. In some embodiments, a sensor may include at least one of a lidar, a cup anemometer, a propeller anemometer, a sonic device, a hot-wire device, a plate anemometer, a tube anemometer, a pitot tube, a vane, or combination thereof.

The systems, techniques, and operations disclosed herein may be additionally or alternatively described by one or more of the following examples.

### Example 1

A method comprising: receiving, by a computing system, at least one sensor measurement, wherein the at least one sensor measurement comprises at least one of a wind speed measurement, or a wind direction measurement; determining, by the computing system, using a stochastic filter, and based on the at least one sensor measurement, at least one predicted attribute of a wake generated by a wind turbine, wherein the wind turbine is one of a plurality of wind turbines of a wind plant; modifying, by the computing system and based on the at least one predicted attribute of the wake, at least one wind turbine control variable for at least one wind turbine of the plurality of wind turbines; and outputting, by the computing system, the at least one wind turbine control variable.

### Example 2

The method of example 1, wherein: the wind turbine comprises a first wind turbine; the wake generated by the first wind turbine comprises a first wake; the method further comprises determining, by the computing system, using the stochastic filter, and based on the at least one sensor measurement, at least one predicted attribute of a second wake generated by a second wind turbine of the plurality of wind turbines; and modifying the at least one wind turbine control variable is further based on the at least one predicted attribute of the second wake.

### Example 3

The method of example 1, wherein determining the at least one predicted attribute of the wake comprises: generating a plurality of sets of data, each set of data in the plurality of sets of data representing a respective hypothetical trajectory of the wake generated by the wind turbine; modifying each set of data in the plurality of sets of data using a respective at least one perturbation value, thereby forming a plurality of modified sets of data, each modified set of data of the plurality of modified sets of data being associated with at least one respective hypothetical measurement; determining, for each modified set of data in the plurality of modified sets of data, based on a respective comparison of the at least one respective hypothetical measurement and the at least one sensor measurement, a respective weight; and determining the at least one predicted attribute of the wake based on the respective weight for each modified set of data.

### Example 4

The method of example 3, wherein: the plurality of sets of data comprises a first plurality of sets of data; the plurality of modified sets of data comprises a first plurality of modified sets of data; and determining the at least one predicted attribute of the wake further comprises: generating, based on the respective weight for each modified set of data in the first plurality of modified sets of data, a second plurality of sets of data, each set of data in the second plurality of sets of data representing a respective updated hypothetical trajectory of the wake generated by the wind turbine, modifying each set of data in the second plurality of sets of data using a second respective at least one perturbation value, thereby forming a second plurality of modified sets of data, each modified set of data of the second plurality of modified sets of data being associated with at least one respective updated hypothetical measurement, and determining, for each modified set of data in the second plurality of modified sets of data, based on a respective comparison of the at least one respective updated hypothetical measurement and the at least one sensor measurement, a respective updated weight, and determining the at least one predicted attribute of the wake based on the respective updated weight for each modified set of data.

### Example 5

The method of example 3, wherein each set of data in the plurality of sets of data comprises data representing at least one of: a number of segments in the respective hypothetical trajectory of the wake; an initial angle of an initial wake segment of the respective hypothetical trajectory of the wake; at least one angle between segments of the respective hypothetical trajectory of the wake; an angle between a segment of the respective hypothetical trajectory of the wake and a reference direction; or an intersection distance between a location along a segment of the respective hypothetical trajectory of the wake and a hub of a second wind turbine of the plurality of wind turbines.

### Example 6

The method of example 5, wherein modifying each set of data in the plurality of sets of data using the respective at least one perturbation value comprises at least one of: applying an initial-angle perturbation value to the data representing the initial angle; or applying at least one angle-between-segments perturbation value to the data representing the at least one angle between segments.

### Example 7

The method of example 6, wherein at least one of the initial angle perturbation value or the at least one angle between segments perturbation value is randomly chosen using a normal distribution.

### Example 8

The method of example 3, wherein determining the respective weight for each modified set of data in the plurality of modified sets of data comprises at least one of: determining, based on (i) data, from the modified set of data, that represents an initial angle of an initial wake segment of the respective hypothetical trajectory of the wake and (ii) the least one sensor measurement, a respective deflection subweight that penalizes hypothetical trajectories of the wake for which the initial angle conflicts with a defined deflection model as applied to the at least one sensor measurement; determining, based on (i) data, from the modified set of data, that represents an angle between a segment of the respective hypothetical trajectory of the wake and a reference direction and (ii) the at least one sensor measurement, a respective tail alignment subweight that penalizes hypothetical trajectories of the wake for which the angle between one or more end wake segments and the reference direction conflict with a free-stream wind direction determined based on the at least one sensor measurement; determining, based on (i) data, from the modified set of data, that represents a respective location of the respective hypothetical trajectory of the wake and (ii) the at least one sensor measurement, a respective intersection subweight that penalizes hypothetical trajectories of the wake for which the respective location conflicts with at least one local wind speed at a downstream turbine, the at least one local wind speed measurement being determined based on the at least one sensor measurement; determining, based on (i) the data that represents the respective location of the respective hypothetical trajectory of the wake and (ii) the at least one sensor measurement, a respective intersection location subweight that penalizes hypothetical trajectories of the wake for which the respective location conflicts with at least one yawing moment of a downstream turbine, the at least one yawing moment being determined based on the at least one sensor measurement; determining, based on data, from the modified set of data, that represents at least one angle between segments of the respective hypothetical trajectory of the wake, a respective straightness subweight that penalizes hypothetical trajectories of the wake that are not straight, as determined based on the at least one angle between segments; or determining, based on the data that represents the at least one angle between segments of the respective hypothetical trajectory of the wake, a respective smoothness subweight that penalizes hypothetical trajectories of the wake that are not smooth, as determined based on the at least one angle between segments.

### Example 9

The method of example 3, wherein determining the at least one predicted attribute of the wake comprises: determining, based on the respective weight for each modified set of data, two or more top weighted modified sets of data of the plurality of modified sets of data; generating, based on the two or more top weighted modified sets of data, a representative set of data that represents a best hypothetical trajectory of the wake generated by the wind turbine; and determining the at least one predicted attribute of the wake based on the representative set of data.

### Example 10

The method of example 1, wherein determining the at least one predicted attribute of the wake comprises: generating a first data representation of a hypothetical trajectory of the wake generated by the wind turbine; updating the first data representation based on a model defining hypothetical wind movements, thereby forming a second data representation, the second data representation being associated with at least one first hypothetical measurement; determining, based on a comparison of the at least one first hypothetical measurement and the at least one sensor measurement, at least one error value; updating, based on the at least one error value and the model defining hypothetical wind movements, the second data representation, thereby forming a third data representation, the third data representation being associated with at least one second hypothetical measurement; and determining the at least one predicted attribute of the wake based on the at least one second hypothetical measurement.

### Example 11

The method of example 1, wherein the at least one sensor measurement further comprises a blade root strain measurement.

### Example 12

The method of example 1, wherein the at least one wind turbine control variable comprises at least one of: a pitch setting, a yaw setting, or a tilt setting.

### Example 13

A system comprising: at least one processor; and at least one module operable by the at least one processor to: receive at least one sensor measurement, wherein the at least one sensor measurement comprises at least one of a wind speed measurement, or a wind direction measurement; determine, using a stochastic filter, and based on the at least one sensor measurement, at least one predicted attribute of a wake generated by a wind turbine, wherein the wind turbine is one of a plurality of wind turbines of a wind plant; modify, based on the at least one predicted attribute of the wake, at least one wind turbine control variable for at least one wind turbine of the plurality of wind turbines; and output the at least one wind turbine control variable.

### Example 14

The system of example 13, wherein: the wind turbine comprises a first wind turbine; the wake generated by the first wind turbine comprises a first wake; the at least one module is further operable by the at least one processor to determine, using the stochastic filter, and based on the at least one sensor measurement, at least one predicted attribute of a second wake generated by a second wind turbine of the plurality of wind turbines; and modifying the at least one wind turbine control variable is further based on the at least one predicted attribute of the second wake.

### Example 15

The system of example 13, wherein the at least one module is operable to determine the at least one predicted attribute of the wake by: generating a plurality of sets of data, each set of data in the plurality of sets of data representing a respective hypothetical trajectory of the wake generated by the wind turbine; modifying each set of data in the plurality of sets of data using a respective at least one perturbation value, thereby forming a plurality of modified sets of data, each modified set of data of the plurality of modified sets of data being associated with at least one respective hypothetical measurement; determining, for each modified set of data in the plurality of modified sets of data, based on a respective comparison of the at least one respective hypothetical measurement and the at least one sensor measurement, a respective weight; and determining the at least one predicted attribute of the wake based on the respective weight for each modified set of data.

### Example 16

The system of example 15, wherein: the plurality of sets of data comprises a first plurality of sets of data; the plurality of modified sets of data comprises a first plurality of modified sets of data; and the at least one module is further operable to determine the at least one predicted attribute of the wake by: generating, based on the respective weight for each modified set of data in the first plurality of modified sets of data, a second plurality of sets of data, each set of data in the second plurality of sets of data representing a respective updated hypothetical trajectory of the wake generated by the wind turbine, modifying each set of data in the second plurality of sets of data using a second respective at least one perturbation value, thereby forming a second plurality of modified sets of data, each modified set of data of the second plurality of modified sets of data being associated with at least one respective updated hypothetical measurement, determining, for each modified set of data in the second plurality of modified sets of data, based on a respective comparison of the at least one respective updated hypothetical measurement and the at least one sensor measurement, a respective updated weight, and determining the at least one predicted attribute of the wake based on the respective updated weight for each modified set of data.

### Example 17

The system of example 15, wherein each set of data in the plurality of sets of data comprises data representing at least one of: a number of segments in the respective hypothetical trajectory of the wake; an initial angle of an initial wake segment of the respective hypothetical trajectory of the wake; at least one angle between segments of the respective hypothetical trajectory of the wake; an angle between a segment of the respective hypothetical trajectory of the wake and a reference direction; or an intersection distance between a location along a segment of the respective hypothetical trajectory of the wake and a hub of a second wind turbine of the plurality of wind turbines.

### Example 18

The system of example 17, wherein the at least one module is operable to modify each set of data in the plurality of sets of data by at least one of: applying an initial-angle perturbation value to the data representing the initial angle; or applying at least one angle-between-segments perturbation value to the data representing the at least one angle between segments.

### Example 19

The system of example 15, wherein the at least one module is operable to determine the at least one predicted attribute of the wake by: determining, based on the respective weight for each modified set of data, two or more top weighted modified sets of data of the plurality of modified sets of data; generating, based on the two or more top weighted modified sets of data, a representative set of data that represents a best hypothetical trajectory of the wake generated by the wind turbine; and determining the at least one predicted attribute of the wake based on the representative set of data.

### Example 20

The system of example 13, wherein the at least one module is operable to determine the at least one predicted attribute of the wake by: generating a first data representation of a hypothetical trajectory of the wake generated by the wind turbine; updating the first data representation based on a model defining hypothetical wind movements, thereby forming a second data representation, the second data representation being associated with at least one first hypothetical measurement; determining, based on a comparison of the at least one first hypothetical measurement and the at least one sensor measurement, at least one error value; updating, based on the at least one error value and the model defining hypothetical wind movements, the second data representation, thereby forming a third data representation, the third data representation being associated with at least one second hypothetical measurement; and determining the at least one predicted attribute of the wake based on the at least one second hypothetical measurement.

### Example 21

A particle filter method for controlling power output from a wind turbine plant that includes a plurality of wind turbines, the method comprising: predicting a first wake trajectory resulting from a first turbine, wherein the first predicted wake trajectory comprises a first vector and a first probability; measuring a metric associated with a first actual wake resulting from a second turbine; based on the measured metric, calculating a second predicted wake trajectory resulting from a third turbine, wherein the second predicted wake trajectory comprises a second vector and a second probability; and based on the second predicted wake trajectory, adjusting a wind turbine control variable for a third turbine, wherein the first turbine, the second turbine, and the third turbine may all be the same turbine, may all be distinctly different turbines, or a combination thereof.

### Example 22

The method of example 21, wherein the predicting further comprises introducing a perturbation to the first probability.

### Example 23

The method of example 21, wherein the first vector comprises at least one segment length, at least one angle, and at least one intersection distance.

### Example 24

The method of example 21, wherein the wind turbine control variable comprises a pitch, a yaw, or a tilt.

### Example 25

The method of example 21, wherein the measured metric comprises a wind speed, a wind direction, or a lidar measurement.

### Example 26

A particle filter system for controlling power output from a wind turbine plant, the system comprising: an upwind turbine, wherein a first orientation of the upwind turbine comprises a first pitch, a first yaw, or a first tilt; a downwind turbine, arranged downwind of the upwind turbine, wherein a second orientation of the downwind turbine comprises a second pitch, a second yaw, or a second tilt; a sensor for measuring at least one metric associated with an actual wake trajectory downwind of the upwind turbine; and a control system comprising a memory and a processor coupled to the memory, the processor comprising: calculation logic that calculates a first predicted wake trajectory for at least one of the upwind turbine or the downwind turbine, wherein the first predicted wake trajectory is based on a perturbation; calculation logic that calculates a second predicted wake trajectory for at least one of the upwind turbine or the downwind turbine, wherein the second predicted trajectory is based on the first predicted wake trajectory and a measurement received from the sensor; and calculation logic that calculates a set point corresponding to a setting for at least one of the first pitch, first yaw, first tilt, second pitch, second yaw, or second tilt.

### Example 27

The system of example 26, further comprising a means for communicating the set point to at least one of the upwind turbine or the downwind turbine.

### Example 28

The system of example 26, wherein the sensor comprises at least one of a lidar, a cup anemometer, a propeller anemometer, a sonic device, a hot-wire device, a plate anemometer, a tube anemometer, a pitot tube, a vane, or combination thereof.

### Example 29

A computer-readable storage medium encoded with instructions that, when executed, cause at least one processor to: receive at least one sensor measurement, wherein the at least one sensor measurement comprises at least one of a wind speed measurement, or a wind direction measurement; determine, using a stochastic filter, and based on the at least one sensor measurement, at least one predicted attribute of a wake generated by a wind turbine, wherein the wind turbine is one of a plurality of wind turbines of a wind plant; modify, based on the at least one predicted attribute of the wake, at least one wind turbine control variable for at least one wind turbine of the plurality of wind turbines; and output the at least one wind turbine control variable.

The techniques described in this disclosure may be implemented, at least in part, in hardware, software, firmware, or any combination thereof. For example, various aspects of the described techniques may be implemented within one or more processors, including one or more microprocessors, digital signal processors (DSPs), application specific integrated circuits (ASICs), field programmable gate arrays (FPGAs), or any other equivalent integrated or discrete logic circuitry, as well as any combinations of such components. The term “processor” or “processing circuitry” may generally refer to any of the foregoing logic circuitry, alone or in combination with other logic circuitry, or any other equivalent circuitry. A control unit including hardware may also perform one or more of the techniques of this disclosure.

Such hardware, software, and firmware may be implemented within the same device or within separate devices to support the various techniques described in this disclosure. In addition, any of the described units, modules or components may be implemented together or separately as discrete but interoperable logic devices. Depiction of different features as modules or units is intended to highlight different functional aspects and does not necessarily imply that such modules or units must be realized by separate hardware, firmware, or software components. Rather, functionality associated with one or more modules or units may be performed by separate hardware, firmware, or software components, or integrated within common or separate hardware, firmware, or software components.

The techniques described in this disclosure may also be embodied or encoded in an article of manufacture including a computer-readable storage medium encoded with instructions. Instructions embedded or encoded in an article of manufacture including a computer-readable storage medium, may cause one or more programmable processors, or other processors, to implement one or more of the techniques described herein, such as when instructions included or encoded in the computer-readable storage medium are executed by the one or more processors. Computer readable storage media may include random access memory (RAM), read only memory (ROM), programmable read only memory (PROM), erasable programmable read only memory (EPROM), electronically erasable programmable read only memory (EEPROM), flash memory, a hard disk, a compact disc ROM (CD-ROM), a floppy disk, a cassette, magnetic media, optical media, or other computer readable storage media. In some examples, an article of manufacture may include one or more computer-readable storage media.

A computer-readable storage medium comprises a non-transitory medium. The term “non-transitory” indicates that the storage medium is not embodied in a carrier wave or a propagated signal. In certain examples, a non-transitory storage medium may store data that can, over time, change (e.g., in RAM or cache).

Various embodiments and techniques have been described. However, it should be understood that many variations and modifications may be made while remaining within the spirit and scope of the disclosure and the following claims.

What is claimed is:

1. A method comprising:
receiving, by a computing system, at least one sensor measurement, wherein the at least one sensor measurement comprises at least one of a wind speed measurement, or a wind direction measurement;
determining, by the computing system, using a stochastic filter, and based on the at least one sensor measurement, at least one predicted attribute of a wake generated by a wind turbine, wherein the wind turbine is one of a plurality of wind turbines of a wind plant;
modifying, by the computing system and based on the at least one predicted attribute of the wake, at least one wind turbine control variable for at least one wind turbine of the plurality of wind turbines; and
outputting, by the computing system, the at least one wind turbine control variable.

2. The method of claim 1, wherein:
the wind turbine comprises a first wind turbine;
the wake generated by the first wind turbine comprises a first wake;
the method further comprises determining, by the computing system, using the stochastic filter, and based on the at least one sensor measurement, at least one predicted attribute of a second wake generated by a second wind turbine of the plurality of wind turbines; and
modifying the at least one wind turbine control variable is further based on the at least one predicted attribute of the second wake.

3. The method of claim 1, wherein determining the at least one predicted attribute of the wake comprises:
generating a plurality of sets of data, each set of data in the plurality of sets of data representing a respective hypothetical trajectory of the wake generated by the wind turbine;
modifying each set of data in the plurality of sets of data using a respective at least one perturbation value, thereby forming a plurality of modified sets of data, each modified set of data of the plurality of modified sets of data being associated with at least one respective hypothetical measurement;
determining, for each modified set of data in the plurality of modified sets of data, based on a respective comparison of the at least one respective hypothetical measurement and the at least one sensor measurement, a respective weight; and
determining the at least one predicted attribute of the wake based on the respective weight for each modified set of data.

4. The method of claim 3, wherein:
the plurality of sets of data comprises a first plurality of sets of data;
the plurality of modified sets of data comprises a first plurality of modified sets of data; and
determining the at least one predicted attribute of the wake further comprises:
generating, based on the respective weight for each modified set of data in the first plurality of modified sets of data, a second plurality of sets of data, each set of data in the second plurality of sets of data representing a respective updated hypothetical trajectory of the wake generated by the wind turbine,
modifying each set of data in the second plurality of sets of data using a second respective at least one perturbation value, thereby forming a second plurality of modified sets of data, each modified set of data of the second plurality of modified sets of data being associated with at least one respective updated hypothetical measurement, and
determining, for each modified set of data in the second plurality of modified sets of data, based on a respective comparison of the at least one respective updated hypothetical measurement and the at least one sensor measurement, a respective updated weight, and
determining the at least one predicted attribute of the wake based on the respective updated weight for each modified set of data.

5. The method of claim 3, wherein each set of data in the plurality of sets of data comprises data representing at least one of:
a number of segments in the respective hypothetical trajectory of the wake;
an initial angle of an initial wake segment of the respective hypothetical trajectory of the wake;
at least one angle between segments of the respective hypothetical trajectory of the wake;
an angle between a segment of the respective hypothetical trajectory of the wake and a reference direction; or
an intersection distance between a location along a segment of the respective hypothetical trajectory of the wake and a hub of a second wind turbine of the plurality of wind turbines.

6. The method of claim 5, wherein modifying each set of data in the plurality of sets of data using the respective at least one perturbation value comprises at least one of:
applying an initial-angle perturbation value to the data representing the initial angle; or
applying at least one angle-between-segments perturbation value to the data representing the at least one angle between segments.

7. The method of claim 6, wherein at least one of the initial angle perturbation value or the at least one angle between segments perturbation value is randomly chosen using a normal distribution.

8. The method of claim 3, wherein determining the respective weight for each modified set of data in the plurality of modified sets of data comprises at least one of:
determining, based on (i) data, from the modified set of data, that represents an initial angle of an initial wake segment of the respective hypothetical trajectory of the wake and (ii) the least one sensor measurement, a respective deflection subweight that penalizes hypothetical trajectories of the wake for which the initial angle conflicts with a defined deflection model as applied to the at least one sensor measurement;
determining, based on (i) data, from the modified set of data, that represents an angle between a segment of the respective hypothetical trajectory of the wake and a reference direction and (ii) the at least one sensor measurement, a respective tail alignment subweight that penalizes hypothetical trajectories of the wake for which the angle between one or more end wake segments and the reference direction conflict with a free-stream wind direction determined based on the at least one sensor measurement;
determining, based on (i) data, from the modified set of data, that represents a respective location of the respective hypothetical trajectory of the wake and (ii) the at least one sensor measurement, a respective intersection subweight that penalizes hypothetical trajectories of the wake for which the respective location conflicts with at least one local wind speed at a downstream turbine, the at least one local wind speed measurement being determined based on the at least one sensor measurement;
determining, based on (i) the data that represents the respective location of the respective hypothetical trajectory of the wake and (ii) the at least one sensor measurement, a respective intersection location subweight that penalizes hypothetical trajectories of the wake for which the respective location conflicts with at least one yawing moment of a downstream turbine, the at least one yawing moment being determined based on the at least one sensor measurement;
determining, based on data, from the modified set of data, that represents at least one angle between segments of the respective hypothetical trajectory of the wake, a respective straightness subweight that penalizes hypothetical trajectories of the wake that are not straight, as determined based on the at least one angle between segments; or
determining, based on the data that represents the at least one angle between segments of the respective hypothetical trajectory of the wake, a respective smoothness subweight that penalizes hypothetical trajectories of the wake that are not smooth, as determined based on the at least one angle between segments.

9. The method of claim 3, wherein determining the at least one predicted attribute of the wake comprises:
determining, based on the respective weight for each modified set of data, two or more top weighted modified sets of data of the plurality of modified sets of data;
generating, based on the two or more top weighted modified sets of data, a representative set of data that represents a best hypothetical trajectory of the wake generated by the wind turbine; and
determining the at least one predicted attribute of the wake based on the representative set of data.

10. The method of claim 1, wherein determining the at least one predicted attribute of the wake comprises:
generating a first data representation of a hypothetical trajectory of the wake generated by the wind turbine;
updating the first data representation based on a model defining hypothetical wind movements, thereby forming a second data representation, the second data representation being associated with at least one first hypothetical measurement;
determining, based on a comparison of the at least one first hypothetical measurement and the at least one sensor measurement, at least one error value;
updating, based on the at least one error value and the model defining hypothetical wind movements, the second data representation, thereby forming a third data representation, the third data representation being associated with at least one second hypothetical measurement; and
determining the at least one predicted attribute of the wake based on the at least one second hypothetical measurement.

11. The method of claim 1, wherein the at least one sensor measurement further comprises a blade root strain measurement.

12. The method of claim 1, wherein the at least one wind turbine control variable comprises at least one of: a pitch setting, a yaw setting, or a tilt setting.

13. A system comprising:
at least one processor; and
at least one module operable by the at least one processor to:
receive at least one sensor measurement, wherein the at least one sensor measurement comprises at least one of a wind speed measurement, or a wind direction measurement;
determine, using a stochastic filter, and based on the at least one sensor measurement, at least one predicted attribute of a wake generated by a wind turbine, wherein the wind turbine is one of a plurality of wind turbines of a wind plant;
modify, based on the at least one predicted attribute of the wake, at least one wind turbine control variable for at least one wind turbine of the plurality of wind turbines; and
output the at least one wind turbine control variable.

14. The system of claim 13, wherein:
the wind turbine comprises a first wind turbine;
the wake generated by the first wind turbine comprises a first wake;
the at least one module is further operable by the at least one processor to determine, using the stochastic filter, and based on the at least one sensor measurement, at least one predicted attribute of a second wake generated by a second wind turbine of the plurality of wind turbines; and
modifying the at least one wind turbine control variable is further based on the at least one predicted attribute of the second wake.

15. The system of claim 13, wherein the at least one module is operable to determine the at least one predicted attribute of the wake by:
generating a plurality of sets of data, each set of data in the plurality of sets of data representing a respective hypothetical trajectory of the wake generated by the wind turbine;
modifying each set of data in the plurality of sets of data using a respective at least one perturbation value, thereby forming a plurality of modified sets of data, each modified set of data of the plurality of modified sets of data being associated with at least one respective hypothetical measurement;
determining, for each modified set of data in the plurality of modified sets of data, based on a respective comparison of the at least one respective hypothetical measurement and the at least one sensor measurement, a respective weight; and
determining the at least one predicted attribute of the wake based on the respective weight for each modified set of data.

16. The system of claim 15, wherein:
the plurality of sets of data comprises a first plurality of sets of data;
the plurality of modified sets of data comprises a first plurality of modified sets of data; and
the at least one module is further operable to determine the at least one predicted attribute of the wake by:
generating, based on the respective weight for each modified set of data in the first plurality of modified sets of data, a second plurality of sets of data, each set of data in the second plurality of sets of data representing a respective updated hypothetical trajectory of the wake generated by the wind turbine,
modifying each set of data in the second plurality of sets of data using a second respective at least one perturbation value, thereby forming a second plurality of modified sets of data, each modified set of data of the second plurality of modified sets of data being associated with at least one respective updated hypothetical measurement,
determining, for each modified set of data in the second plurality of modified sets of data, based on a respective comparison of the at least one respective updated hypothetical measurement and the at least one sensor measurement, a respective updated weight, and
determining the at least one predicted attribute of the wake based on the respective updated weight for each modified set of data.

17. The system of claim 15, wherein each set of data in the plurality of sets of data comprises data representing at least one of:
a number of segments in the respective hypothetical trajectory of the wake;
an initial angle of an initial wake segment of the respective hypothetical trajectory of the wake;
at least one angle between segments of the respective hypothetical trajectory of the wake;
an angle between a segment of the respective hypothetical trajectory of the wake and a reference direction; or
an intersection distance between a location along a segment of the respective hypothetical trajectory of the wake and a hub of a second wind turbine of the plurality of wind turbines.

18. The system of claim 17, wherein the at least one module is operable to modify each set of data in the plurality of sets of data by at least one of:
applying an initial-angle perturbation value to the data representing the initial angle; or
applying at least one angle-between-segments perturbation value to the data representing the at least one angle between segments.

19. The system of claim 15, wherein the at least one module is operable to determine the at least one predicted attribute of the wake by:
determining, based on the respective weight for each modified set of data, two or more top weighted modified sets of data of the plurality of modified sets of data;
generating, based on the two or more top weighted modified sets of data, a representative set of data that represents a best hypothetical trajectory of the wake generated by the wind turbine; and
determining the at least one predicted attribute of the wake based on the representative set of data.

20. A computer-readable storage medium encoded with instructions that, when executed, cause at least one processor to:
receive at least one sensor measurement, wherein the at least one sensor measurement comprises at least one of a wind speed measurement, or a wind direction measurement;
determine, using a stochastic filter, and based on the at least one sensor measurement, at least one predicted attribute of a wake generated by a wind turbine, wherein the wind turbine is one of a plurality of wind turbines of a wind plant;
modify, based on the at least one predicted attribute of the wake, at least one wind turbine control variable for at least one wind turbine of the plurality of wind turbines; and
output the at least one wind turbine control variable.
